(19) United States
(12) Patent Application Publication
(10) Pub. No.: US 2015/0339855 A1
(43) Pub. Date: Nov. 26, 2015

(54) LASER POINTER SELECTION FOR AUGMENTED REALITY DEVICES

(71) Applicant: International Business Machines Corporation, Armonk, NY (US)

(72) Inventors: Jorge L. Diaz, Cincinnati, OH (US); Richard W. Ragan, JR., Round Rock, TX (US); Fa Ming Yang, Shanghai (CN); Yue Yuan, Shanghai (CN)

(73) Assignee: International Business Machines Corporation, Armonk, NY (US)

(21) Appl. No.: 14/282,076

(22) Filed: May 20, 2014

(51) Int. Cl. G06T 19/00; G06F 3/03; G02B 27/01

(52) U.S. Cl. CPC G06T 19/006; G02B 27/0101; G06F 3/0304

(57) ABSTRACT

In an approach to selecting a real world object for display in an augmented reality view using a laser signal, one or more computer processors determine a real world environment being viewed in an augmented reality view. The one or more computer processors recognize a laser light signature signal originating from an object in the real world environment. The one or more computer processors receive a selection of the object, based, at least in part, on the recognized laser light signature signal. The one or more computer processors display the selected object in the augmented reality view.

### BACKGROUND OF THE INVENTION

The present invention relates generally to the field of augmented reality, and more particularly to the use of a laser pointer for accurately selecting a real world object for display in an augmented reality view.

Augmented reality comprises an area of known endeavor. Generally speaking, augmented reality comprises a live, direct (or indirect) view of a physical, real world environment having contents that are augmented by computer-generated sensory input such as visually-perceivable content. In many cases the augmented reality system aligns the overlaid imagery with specific elements of the physical world. Some augmented reality approaches rely, at least in part, upon a head-mounted display. These head-mounted displays often have the form-factor of a pair of glasses. Such displays place contrived images over a portion, though typically not all of, a user's view of the world. Such head-mounted displays are typically either optical see-through mechanisms or video-based mechanisms.

Augmented reality glasses may provide an enhanced view of the real world environment by incorporating computer-generated information with a view of the real world. Such display devices may further be remote wireless display devices such that the remote display device provides an enhanced view by incorporating computer-generated information with a view of the real world. In particular, augmented reality devices, such as augmented reality glasses, may provide for overlaying virtual graphics over a view of the physical world. As such, methods of navigation and transmission of other information through augmented reality devices may provide for richer and deeper interaction with the surrounding environment. The usefulness of augmented reality devices relies upon supplementing the view of the real world with meaningful and timely virtual graphics.

### SUMMARY

According to one embodiment of the present invention, a method for selecting a real world object for display in an augmented reality view using a laser signal. The method for selecting a real world object for display in an augmented reality view using a laser signal may include one or more computer processors determining a real world environment being viewed in an augmented reality view. The one or more computer processors recognize a laser light signature signal originating from an object in the real world environment. The one or more computer processors receive a selection of the object, based, at least in part, on the recognized laser light signature signal. The one or more computer processors display the selected object in the augmented reality view.

### BRIEF DESCRIPTION OF THE SEVERAL VIEWS OF THE DRAWINGS

FIG. 1 is a functional block diagram illustrating an augmented reality data processing environment, in accordance with an embodiment of the present invention;

FIG. 2 is a flowchart depicting operational steps of a laser selection program, on a client computing device within the augmented reality data processing environment of FIG. 1, for selecting real world objects viewed in an augmented reality environment, in accordance with an embodiment of the present invention;

FIG. 3A depicts a laser affixed to augmented reality glasses, in accordance with an embodiment of the present invention;

FIG. 3B illustrates an example of the usage of the laser selection program, operating on a client computing device within the augmented reality data processing environment of FIG. 1, in accordance with an embodiment of the present invention; and

FIG. 4 depicts a block diagram of components of the client computing device executing the laser selection program, in accordance with an embodiment of the present invention.

### DETAILED DESCRIPTION

Augmented reality glasses enable a user to merge a real world experience with a virtual world via a visual overlay to supplement what the user views. Connection to a computer network and various databases allows the augmented reality glasses to add information to the user's view of the environment through the overlay. For example, if a viewer's gaze is directed to a restaurant, then the augmented reality glasses may provide properties of that restaurant, including menu, hours of operation, and customer reviews. However, if a user's view includes several restaurants, then it may be difficult for the user to indicate to the augmented reality glasses the restaurant on which to focus. Although functionality of the augmented reality glasses may allow the user to provide spoken instructions, a noisy environment may impede this functionality.

Embodiments of the present invention recognize that efficiency can be gained by implementing a method of object selection for augmented reality glasses that utilizes a laser pointer for selection accuracy. Implementation of embodiments of the invention may take a variety of forms, and exemplary implementation details are discussed subsequently with reference to the Figures.

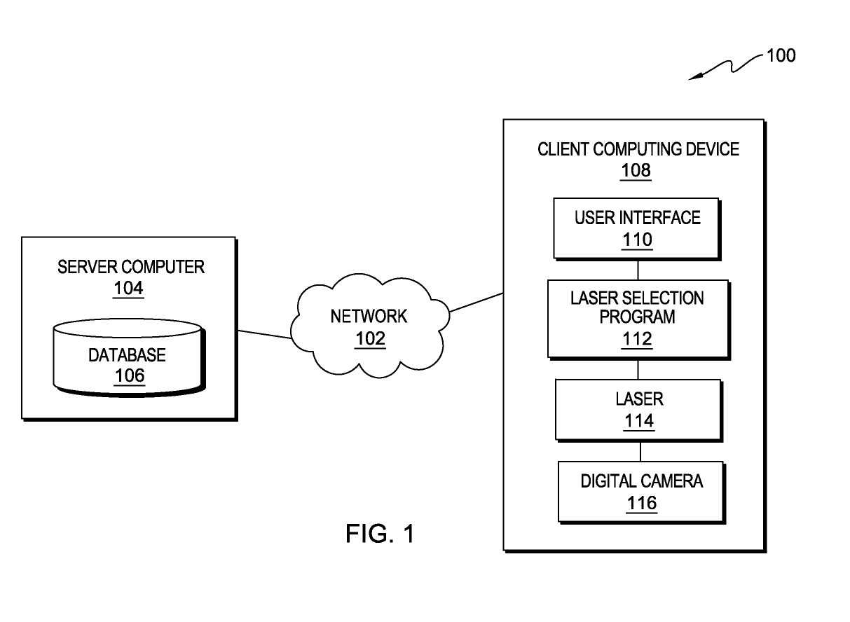

FIG. 1 is a functional block diagram illustrating an augmented reality data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Augmented reality data processing environment 100 includes server computer 104 and client computing device 108, interconnected over network 102. Network 102 can be, for example, a telecommunications network, a local area network (LAN), a wide area network (WAN), such as the Internet, or a combination of the two, and can include wired, wireless, or fiber optic connections. In general, network 102 can be any combination of connections and protocols that will support communications between server computer 104 and client computing device 108.

Server computer 104 may be a management server, a web server, or any other electronic device or computing system capable of receiving and sending data. In other embodiments, server computer 104 may represent a server computing system utilizing multiple computers as a server system, such as in a cloud computing environment. In another embodiment, server computer 104 may be a laptop computer, a tablet computer, a netbook computer, a personal computer (PC), a desktop computer, a personal digital assistant (PDA), a smart phone, or any programmable electronic device capable of communicating with client computing device 108 via network 102. In another embodiment, server computer 104 represents a computing system utilizing clustered computers and components to act as a single pool of seamless resources. Server computer 104 includes database 106.

Database 106 resides on server computer 104. In another embodiment, database 106 may reside on client computing device 108, or on another device or component (not shown) within augmented reality data processing environment 100 accessible via network 102. A database is an organized collection of data. Database 106 can be implemented with any type of storage device capable of storing data that may be accessed and utilized by server computer 104, such as a database server, a hard disk drive, or a flash memory. In other embodiments, database 106 can represent multiple storage devices within server computer 104. Database 106 stores data regarding the identification and related information of a plurality of objects and locations that the user of client computing device 108 may access or view. Database 106 may receive regular updates, via network 102, regarding new objects and locations, as well as additional information related to objects and locations that are currently stored.

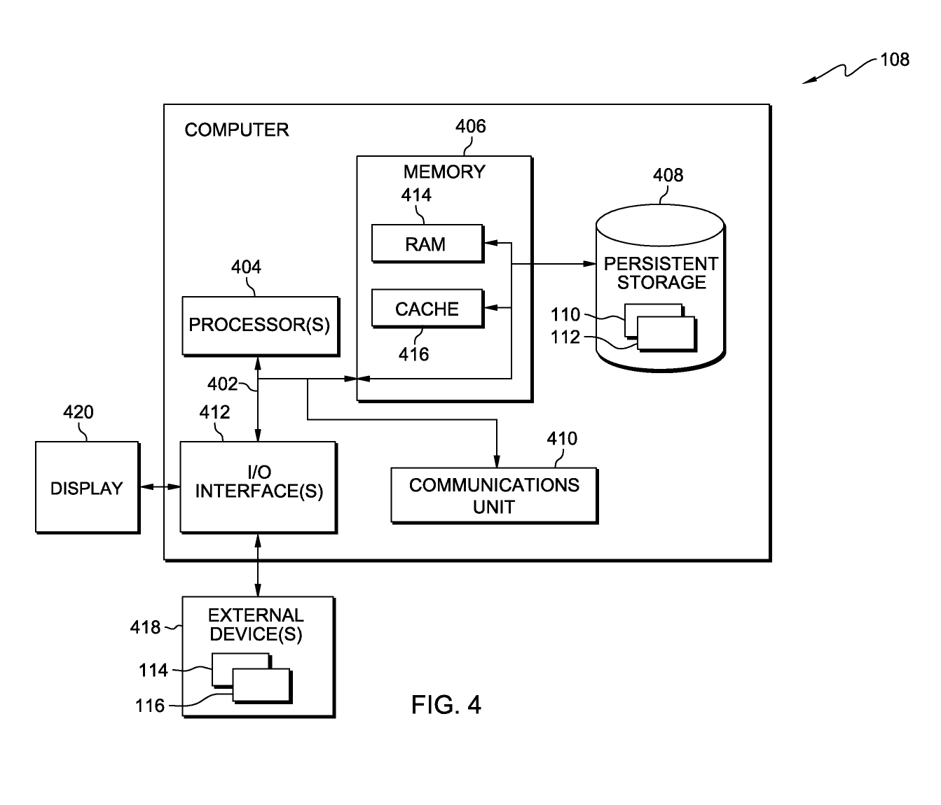

Client computing device 108 may be a desktop computer, a laptop computer, a tablet computer, a specialized computer server, a smart phone, or any programmable electronic device capable of communicating with server computer 104 via network 102 and with various components and devices within augmented reality data processing environment 100. Client computing device 108 may be a wearable computer. Wearable computers are miniature electronic devices that may be worn by the bearer under, with or on top of clothing, as well as in glasses, hats, or other accessories. Wearable computers are especially useful for applications that require more complex computational support than just hardware coded logics. In general, client computing device 108 represents any programmable electronic device or combination of programmable electronic devices capable of executing machine readable program instructions and communicating with other computing devices via a network, such as network 102. Client computing device 108 includes user interface 110, laser selection program 112, laser 114, and digital camera 116. Client computing device 108 may include internal and external hardware components, as depicted and described in further detail with respect to FIG. 4.

User interface 110 is a program that provides an interface between a user of client computing device 108 and laser selection program 112. A user interface, such as user interface 110, refers to the information (such as graphic, text, and sound) that a program presents to a user and the control sequences the user employs to control the program. There are many types of user interfaces. In one embodiment, user interface 110 is a graphical user interface. A graphical user interface (GUI) is a type of user interface that allows users to interact with electronic devices, such as a computer keyboard and mouse, a touchpad, or a digital camera, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In one embodiment, user interface 110 is the interface between client computing device 108 and laser selection program 112. In other embodiments, user interface 110 provides an interface between laser selection program 112 and database 106, which resides on server computer 104. In one embodiment, the user interface input technique may utilize a digital camera, such as digital camera 116. In another embodiment, the user interface technique may utilize a microphone.

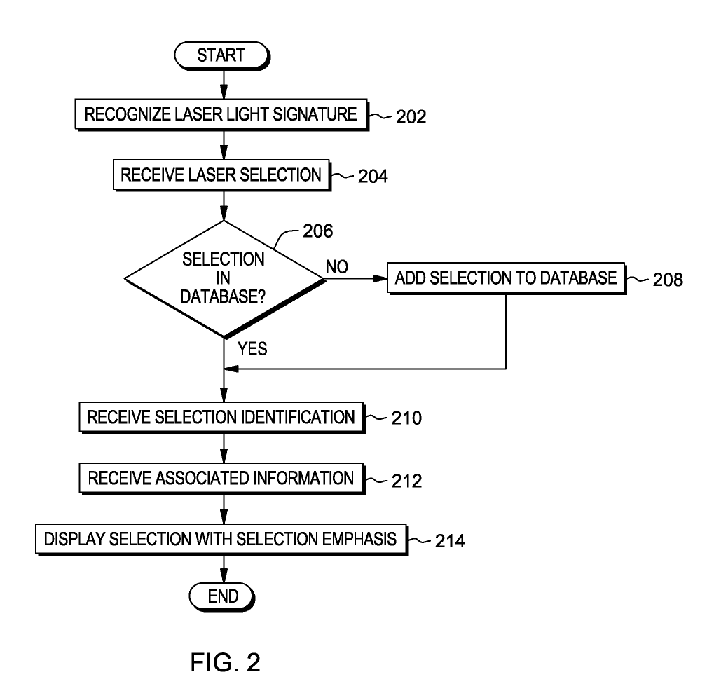

Laser selection program 112 recognizes the signature of laser 114 and associates the laser signature with an object at which laser 114 points. Laser selection program 112 allows a user of client computing device 108 to select an object in the real world using a laser associated with client computing device 108, such as laser 114, and enables client computing device 108 to display information associated with the selected object. Laser selection program 112 is depicted and described in further detail with respect to FIG. 2.

Laser 114 is a small device with a power source (typically a battery) and a laser diode emitting a narrow coherent low-powered laser beam of visible light, intended to be used to highlight a physical object of interest by illuminating it with a spot of light. The spot of light may appear in a plurality of shapes, colors, and brightnesses. In one embodiment, laser 114 is affixed to client computing device 108. In another embodiment, laser 114 may be handheld with the capability of communicating, via network 102, with client computing device 108. In yet another embodiment, laser 114 may be affixed to a second client computing device within augmented reality data processing environment 100, provided the second client computing device is capable of communicating with client device 108 via network 102.

Digital camera 116 resides on client computing device 108. In another embodiment, digital camera 116 may reside on a second client computing device within augmented reality data processing environment 100, provided the second client computing device is capable of communicating with client device 108 via network 102. A digital camera is a camera that encodes digital images and videos digitally and stores them for later reproduction. Digital camera 116 acts as an input device for client computing device 108. Digital camera 116 renders a digital image of an object selected by laser selection program 112. Laser selection program 112 compares the image taken by digital camera 114 to images in database 106.

FIG. 2 is a flowchart depicting operational steps of laser selection program 112, on client computing device 108 within augmented reality data processing environment 100 of FIG. 1, for selecting real world objects viewed in an augmented reality environment, in accordance with an embodiment of the present invention.

Laser selection program 112 recognizes a laser light signature (step 202). In one embodiment, client computing device 108 is a wearable computer, for example, augmented reality glasses. A user of client computing device 108 may be continually viewing the surrounding real world environment. As the user views the real world environment, client computing device 108 is scanning images of the objects and locations in view with digital camera 116. In this embodiment, objects may include people, as facial recognition software is known in the art. Through software implementations known in the art, client computing device 108 is aware of the user's current location and is aware of the objects and locations for which client computing device 108 retrieves associated information from database 106. In one embodiment, client computing device 108 may utilize a global positioning system (GPS) to determine location. In another embodiment, client computing device 108 may interact, via network 102, with a social network program, and determine a user's location by retrieving the user's status update.

Laser selection program 112 determines, based on the recognition of the laser light signature, an object or location from the viewed items, either by recognizing the items by comparing the items to known database images, or by a request from the user, via user interface 110. There may be several means of making a selection. In one embodiment, a laser pointer, such as laser 114, is affixed to client computing device 108, and a user may point laser 114 toward an object or location in the real world for which the user desires information. Laser 114 may display a spot of light, such as a small red spot, on the selected object in the real world view. In an embodiment where client computing device 108 is a pair of augmented reality glasses, the pointing of laser 114 is achieved by moving the glasses with the user's head such that laser 114 points to the object of interest. Laser selection program 112 recognizes the signature light pulses from laser 114 as the pulses bounce off of a selected object. The signature light pulses, for example, discrete dots and dashes or short and long intervals or flickers, allow laser selection program 112 to recognize the signal that originates from laser 114, affixed to client computing device 108, distinguishes laser 114 from another laser pointer.

Laser selection program 112 receives the laser selection (step 204). Responsive to recognizing the signal coming from laser 114, laser selection program 112 receives an image of the selected object from digital camera 116, including the red spot from laser 114, and associates the signal with a selection of the object or location to which laser 114 points. For example, a user points laser 114 at a restaurant on a city street, and laser selection program 112 receives the selection of the restaurant as an image of the restaurant recorded by digital camera 116.

Laser selection program 112 determines whether the selection is in database 106 (decision block 206). If the selection is not in database 106 (no branch, decision block 206), then laser selection program 112 adds the selection to database 106 (step 208). If the selection is not in database 106, then laser selection program 112 may prompt the user, via user interface 110, to provide an identification for the selected object. In one embodiment, laser selection program 112 may display a request for information via user interface 110, and the user may respond to the question by speaking a response. For example, laser selection program 112 may display “Please name the selected object”, and the user responds by saying “Broadway Diner.” Upon receiving a response, laser selection program 112 adds the identification to database 106. In another embodiment, the user may respond to a question via typing a response in the user's smart phone which can communicate with client computing device 108 via network 102. Upon receiving a response, laser selection program 112 adds the identification to database 106. In another embodiment, laser selection program 112 may assign a generic identification to the selected object, for example “restaurant”, and add the generic identification to database 106. A user may choose to edit the generic identification at another time via user interface 110.

If the selection is in database 106 (yes branch, decision block 206), or is added to database 106 per step 208, then laser selection program 112 receives the selection identification (step 210). Identification algorithms within client computing device 108 provide laser selection program 112 with the identification of the selected object. For example, if the user has selected a restaurant by pointing laser 114 at a sign on the front of a building, then, after receiving the image of the sign from digital camera 116, laser selection program 112 receives the name of the restaurant from database 106.

Laser selection program 112 receives associated information (step 212). Contained within database 106, in addition to stored object identifications, is information associated with each of the stored objects. The associated information, or metadata, for each object may be displayed for the benefit of the user. For example, if the user has selected a restaurant by pointing laser 114 at the sign on the front of the building, then laser selection program 112 receives information associated with the restaurant, i.e. menu, hours of operation, customer reviews, etc., retrieved by client computing device 108 from database 106. If laser selection program 112 adds the selected object to database 106 in step 208, there may be minimal associated information available from database 106. As database 106 is updated, additional associated information may be added, and subsequent selections of the same object may enable laser selection program 112 to receive the associated information.

Laser selection program 112 displays the selection with selection emphasis (step 214). In some embodiments, in addition to the selection with selection emphasis, laser selection program 112 also displays the information associated with the selection. In order to specifically identify the selected object in the user's augmented reality view, laser selection program 112 adds selection emphasis to the selected object. For example, laser selection program 112 may display a shape, such as a black or white rectangle surrounding the object at which laser 114 points within the overlay display. Selection emphasis in this manner is similar to known GUI techniques where a user points a cursor at a selection on a computer screen, and the selection is highlighted. For example, if a worker on a shipping dock views a stack of many shipping containers, then the worker may select a specific shipping container for determination of associated data by pointing laser 114 at the specific container. Laser selection program 112 displays the selected container in the augmented reality view by surrounding the selected container with a white rectangle. The white rectangle identifies the shipping container as uniquely selected from the other containers in view. In addition to the selected object with selection emphasis, laser selection program 112 displays the information associated with the selected object received from database 106 in step 212 to provide the augmented reality view.

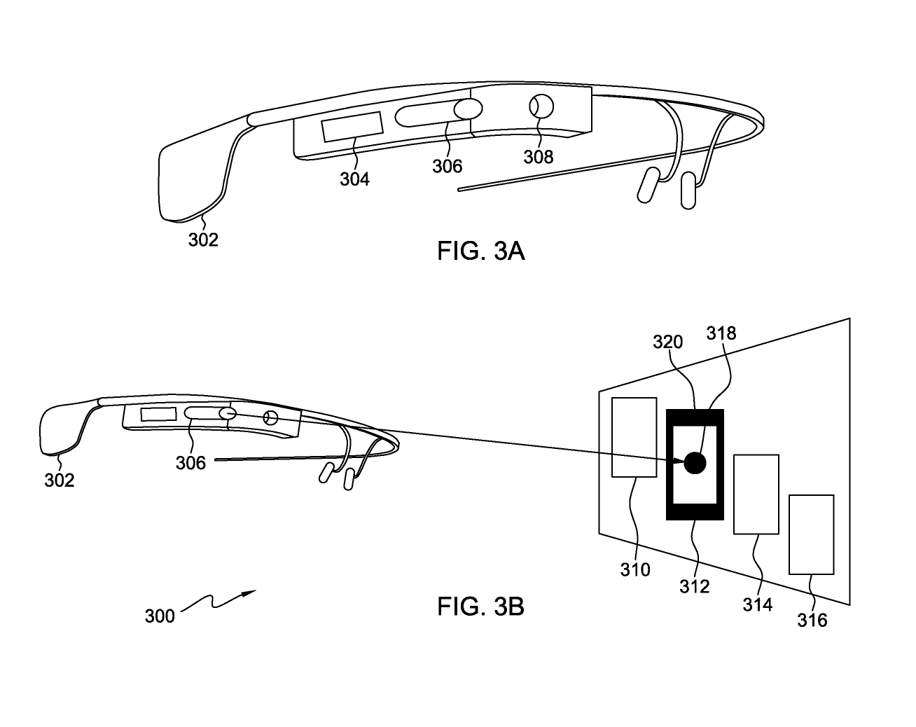

FIG. 3A depicts laser 306 affixed to augmented reality glasses 302, in accordance with an embodiment of the present invention. Augmented reality glasses 302 represent client computing device 108, as depicted and described with reference to FIG. 1. Touchpad 304 allows a user to access user interface 110, similar to a mouse or a keyboard interfaces with a computer. Laser 306 depicts the affixed laser residing on augmented reality glasses 302 and is capable of projecting a spot of light onto an object. Digital camera 308 acts as an input device for user interface 110. Digital camera 308 records images of the real world within view, as well as the spot created by laser 306, to send to the database for visual matching of real world objects to known objects in the database, as well as allowing a user to photograph an object in the real world.

FIG. 3B illustrates an example of the usage of laser selection program 112, operating on client computing device 108 within augmented reality data processing environment 100 of FIG. 1, in accordance with an embodiment of the present invention. In the example, augmented reality glasses 302 represent client computing device 108, as depicted and described with reference to FIG. 1. The user of augmented reality glasses 302 views an environment containing objects 310, 312, 314, and 316. The user is pointing laser 306, via head movements, at object 312. Spot 318 in the center of object 312 indicates that laser 306 points at object 312 in the real world. Laser selection program 112 recognizes the laser light signature bounced back to augmented reality glasses 302 from spot 318, per step 202 as depicted and described with reference to FIG. 2, and receives the selection of object 312, per step 204 of FIG. 2. In example 300, object 312 is located within database 106, and laser selection program 112 receives the identification and associated information of object 312, per steps 210 and 212 of FIG. 2. Black rectangle 320 surrounding object 312 indicates selection emphasis which the user views in the augmented reality view which augmented reality glasses 302 displays, per step 214 of FIG. 2.

FIG. 4 depicts a block diagram of components of client computing device 108 executing laser selection program 112, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Client computing device 108 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

User interface 110 and laser selection program 112 are stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of server computer 104. In these examples, communications unit 410 includes one or more network interface cards. Communications unit 410 may provide communications through the use of either or both physical and wireless communications links. User interface 110 and laser selection program 112 may be downloaded to persistent storage 408 through communications unit 410.

I/O interface(s) 412 allows for input and output of data with other devices that may be connected to client computing device 108. For example, I/O interface(s) 412 may provide a connection to external device(s) 418 such as a keyboard, a keypad, a touch screen, a microphone, a laser signal device, a digital camera, and/or some other suitable input device. A laser signal device, such as laser 114, and a digital camera, such as digital camera 116, may be communicatively coupled to processor(s) 404. External device(s) 418 can also include portable computer readable storage media such as, for example, thumb drives, portable optical or magnetic disks, and memory cards. Software and data used to practice embodiments of the present invention, e.g., user interface 110 and laser selection program 112, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for selecting a real world object for display in an augmented reality view using a laser signal, the method comprising:
determining, by one or more computer processors, a real world environment being viewed in an augmented reality view;
recognizing, by the one or more computer processors, a laser light signature signal originating from an object in the real world environment;
receiving, by the one or more computer processors, a selection of the object, based, at least in part, on the recognized laser light signature signal; and
displaying, by the one or more computer processors, the selected object in the augmented reality view.

2. The method of claim 1, further comprising:
responsive to receiving a selection of the object, based, at least in part, on the recognized laser light signature signal, determining, by the one or more computer processors, whether an image of the selected object is stored in at least one database associated with the laser light signature signal; and
responsive to determining that an image of the selected object is stored in at least one database associated with the laser light signature signal, receiving, by the one or more computer processors, identification information associated with the selected object.

3. The method of claim 2, further comprising displaying, by the one or more computer processors, the identification information associated with the selected object.

4. The method of claim 1, wherein displaying the selection of the object further comprises displaying, by the one or more computer processors, the object with emphasis such that the selected object is displayed as being uniquely selected from one or more other objects in the augmented reality view of the real world environment.

5. The method of claim 4, wherein displaying the object with emphasis includes displaying the object with a surrounding shape.

6. The method of claim 1, wherein the laser light signature signal distinguishes the recognized laser light signature signal from one or more laser light signature signals originating from one or more additional laser lights.

7. The method of claim 1, wherein the laser light signature signal originates from a laser signal device affixed to a computing device operated by a user to view the real world environment in the augmented reality view.

8. A computer program product for selecting a real world object for display in an augmented reality view using a laser signal, the computer program product comprising:
one or more computer readable storage media and program instructions stored on the one or more computer readable storage media, the program instructions comprising:
program instructions to determine a real world environment being viewed in an augmented reality view;
program instructions to recognize a laser light signature signal originating from an object in the real world environment;
program instructions to receive a selection of the object, based, at least in part, on the recognized laser light signature signal; and
program instructions to display the selected object in the augmented reality view.

9. The computer program product of claim 8, further comprising:
responsive to receiving a selection of the object, based, at least in part, on the recognized laser light signature signal, program instructions to determine whether an image of the selected object is stored in at least one database associated with the laser light signature signal; and
responsive to determining that an image of the selected object is stored in at least one database associated with the laser light signature signal, program instructions to receive identification information associated with the selected object.

10. The computer program product of claim 9, further comprising displaying, by the one or more computer processors, the identification information associated with the selected object.

11. The computer program product of claim 8, wherein displaying the selection of the object further comprises program instructions to display the object with emphasis such that the selected object is displayed as being uniquely selected from one or more other objects in the augmented reality view of the real world environment.

12. The computer program product of claim 11, wherein program instructions to display the object with emphasis includes program instructions to display the object with a surrounding shape.

13. The computer program product of claim 8, wherein the laser light signature signal distinguishes the recognized laser light signature signal from one or more laser light signature signals originating from one or more additional laser lights.

14. The computer program product of claim 8, wherein the laser light signature signal originates from a laser signal device affixed to a computing device operated by a user to view the real world environment in the augmented reality view.

15. A computer system for selecting a real world object for display in an augmented reality view using a laser signal, the computer system comprising:
one or more computer processors;
one or more computer readable storage media;
one or more computer processors in communication with the one or more computer readable storage media, the one or more computer processors communicatively coupled to a laser signal device and a digital camera;
program instructions stored on the computer readable storage media for execution by at least one of the one or more processors, the program instructions comprising:
program instructions to determine a real world environment being viewed in an augmented reality view;
program instructions to recognize a laser light signature signal originating from an object in the real world environment;
program instructions to receive a selection of the object, based, at least in part, on the recognized laser light signature signal; and
program instructions to display the selected object in the augmented reality view.

16. The computer system of claim 15, further comprising:
responsive to receiving a selection of the object, based, at least in part, on the recognized laser light signature signal, program instructions to determine whether an image of the selected object is stored in at least one database associated with the laser light signature signal; and
responsive to determining that an image of the selected object is stored in at least one database associated with the laser light signature signal, program instructions to receive identification information associated with the selected object.

17. The computer system of claim 16, further comprising displaying, by the one or more computer processors, the identification information associated with the selected object.

18. The computer system of claim 15, wherein displaying the selection of the object further comprises program instructions to display the object with emphasis such that the selected object is displayed as being uniquely selected from one or more other objects in the augmented reality view of the real world environment.

19. The computer system of claim 15, wherein the laser light signature signal distinguishes the recognized laser light signature signal from one or more laser light signature signals originating from one or more additional laser lights.

20. The computer system of claim 15, wherein the computer system is a wearable device.
